(19) United States
(12) Patent Application Publication
(10) Pub. No.: US 2018/0297455 A1
(43) Pub. Date: Oct. 18, 2018

(54) REMOVABLE INTEGRATED DOOR AND REMOVABLE CHAIR SYSTEM FOR VEHICLES

(71) Applicants: Edward Ray Hale, Southlake, TX (US); Richard Brent Hale, Tyler, TX (US); Stephen Wesley Hale, Dallas, TX (US)

(72) Inventors: Edward Ray Hale, Southlake, TX (US); Richard Brent Hale, Tyler, TX (US); Stephen Wesley Hale, Dallas, TX (US)

(21) Appl. No.: 15/951,635

(22) Filed: Apr. 12, 2018

Related U.S. Application Data
(60) Provisional application No. 62/485,432, filed on Apr. 14, 2017.

(51) Int. Cl. B60J 5/04; B60R 11/00

(52) U.S. Cl. CPC B60J 5/0487; B60J 5/0493; B60R 2011/0001; B60J 5/0413; B60R 11/00; B60J 5/0415

(57) ABSTRACT

The present invention relates to multi-use removable doors for vehicles. The doors serve multiple functions, including as exterior doors for the vehicle, as supports for integrated, removable tables or chairs, as folding outdoor furniture, or as storage compartments. In a preferred embodiment, each door comprises a hinged portion for connecting to the vehicle and a latching mechanism for attaching an integrated folding chair designed specially to fit the contour of the removable door.

This application claims priority to U.S. Provisional Application No. 62/485,432, filed on Apr. 14, 2017. The disclosure of the above-cited application is incorporated by reference in its entirety.

### FIELD OF THE INVENTION

The present invention relates generally to removable doors for vehicles, and more particularly to doors that have expanded functionality. For example, the doors of the present invention may be used to secure integrated but removable items such as outdoor chairs, tables, storage bins, or other objects, or they may themselves unfold or otherwise transform to perform other functions.

### BACKGROUND OF THE INVENTION

Many people enjoy camping and other outdoor activities. Often times people pack equipment, food, and other supplies to camp overnight, to go fishing or hunting, to go to the beach, or to attend a concert, parade, or other festival. Space limitations in vehicles can be a problem, particularly when multiple people travel together or when many supplies are packed for a trip or event. This is particularly true when traveling in smaller vehicles with limited storage space such as the more popular all-terrain vehicles.

Additionally, certain supplies like tables, chairs, storage containers, and the like may take up significant room in a vehicle, limiting space for other travelers, food, and supplies.

The present invention comprises a multiple-use door for vehicles that serves as a securing mechanism for integrated but removable chairs, tables, storage bins, or other objects. Additionally, in an alternate embodiment of the invention, the door itself unfolds or otherwise transforms into a door or table for practical use.

### SUMMARY OF THE INVENTION

The present invention relates to multi-use removable doors for vehicles. The doors serve multiple functions, including as exterior doors for the vehicle, as supports for integrated, removable tables or chairs, as folding outdoor furniture, or as storage compartments. In a preferred embodiment, each door comprises a hinged portion for connecting to the vehicle and a latching mechanism for attaching an integrated folding chair designed specially to fit the contour of the removable door.

It is one object of the present invention to provide a system for specially designed removable doors for vehicles, such as but not limited to Jeep Wrangler-type vehicles or other all-terrain type vehicles.

It is a further object of the present invention to provide a system that uses the existing hinges and door locks of a vehicle for purposes of attaching an exo-skeleton type door that may integrally attach a number of useful objects, such as chairs, tables, storage bins, survival kits, other emergency equipment, or other specially designed products.

These objectives are illustrative in nature. Additional advantages and applications for the present invention will be readily apparent to persons skilled in the art upon a review of the invention and the disclosures contained herein.

### BRIEF DESCRIPTION OF THE DRAWINGS

The drawings referenced below are included so that the features and advantages of the presently disclosed invention may be better understood. It should be noted, however, that the attached drawings are meant only to be illustrative of particular embodiments of the invention and should not be considered limiting of its scope. The invention itself, as well as a preferred mode of use, further objectives and advantages thereof, will best be understood by reference to the following detailed description of the preferred embodiment when read in conjunction with the attached drawings, which are summarized below:

FIG. 1 depicts a vehicle featuring a removable integrated door and removable chair system in accordance with one embodiment of the present invention.

FIG. 2 is a multi-view depiction of a door unit portion of the embodiment depicted in FIG. 1.

FIG. 3 is a multi-view depiction of the removable integrated door and removable chair system of FIG. 1.

FIG. 4 features isometric views of two sides of a driver's side door unit without removable chair system in accordance with one embodiment of the present invention.

FIG. 5 features additional isometric views of two sides of a driver's side door unit without removable chair system in accordance with one embodiment of the present invention.

FIG. 6 features isometric views of two sides of a driver's side integrated door and removable chair system in accordance with one embodiment of the present invention.

FIG. 7 features isometric views of two sides of a removable chair unit portion of one embodiment of the present invention.

FIG. 8 features isometric views of two sides of a driver's side integrated door and removable storage bin in accordance with one aspect of the present invention.

FIG. 9 features isometric views of two sides of a removable storage bin portion of the embodiment depicted in FIG. 8.

### DETAILED DESCRIPTION OF THE INVENTION

Presently preferred embodiments of the invention are shown in the above-identified figures and described in detail below. In describing the preferred embodiments, like or identical reference numerals are used to identify common or similar elements. The figures are not necessarily to scale, and certain features and certain views of the figures may be shown exaggerated in scale or in schematic in the interest of clarity and conciseness.

The present invention relates to specially designed removable doors for vehicles, such as but not limited to Jeep Wrangler-type vehicles or other all-terrain vehicles. Disclosed herein as a preferred embodiment is a system that uses the existing hinges and door locks of a vehicle for purposes of attaching an exo-skeleton type door that may integrally attach a number of useful objects, such as chairs, tables, storage bins, survival kits, other emergency equipment, or other specially designed products. The exo-skeleton frame/door is ideally made from steel but could also be made from other materials, including but not limited to aluminum, titanium, carbon-fiber, molded plastic, wood, or a combination of materials. There are ideally three attachment points on the exo-skeleton frame/door, as described further in the exemplary embodiments below. However, the door could have more or fewer attachment points. The attachment points connect the door of the present invention to the existing frame of a vehicle and allow the door to be removed when the integral components are needed. Two attachment points would typically be on the end of the door positioned near the front-side of the vehicle, while a single attachment would be at the rear side of the door at the door handle. Alternately, the attached objects could be held on by more or fewer attachment points—for example, a single attachment point if the hinge or other connection mechanism were simpler, better, or stronger.

FIG. 1 depicts a vehicle featuring a removable integrated door and removable chair system in accordance with one embodiment of the present invention. Here, integrated door and removable chair system 1 is attached to a vehicle 29. Integrated door and removable chair system 1 has a forward portion and a rear portion, said forward portion attached to vehicle 29 near the front windshield and said rear portion attached to vehicle 29 near the front seat. The integrated door and removable chair system 1 comprises a door unit 2 and a removable chair unit 3, as shown. Integrated door and removable chair system 1 is attached to vehicle 29 by means of an upper hinge 4 and a lower hinge 5, both at the forward end and part of the door unit 2, and a door latching mechanism (not shown), which is compatible with the existing door latch of vehicle 29. The door unit 2 also preferable has a door handle 7, which is used to open the door unit 2 like a standard vehicle door, and a lock 6, which may be used to secure the door unit 2 so that it will not open unless unlocked (again, like a standard vehicle door).

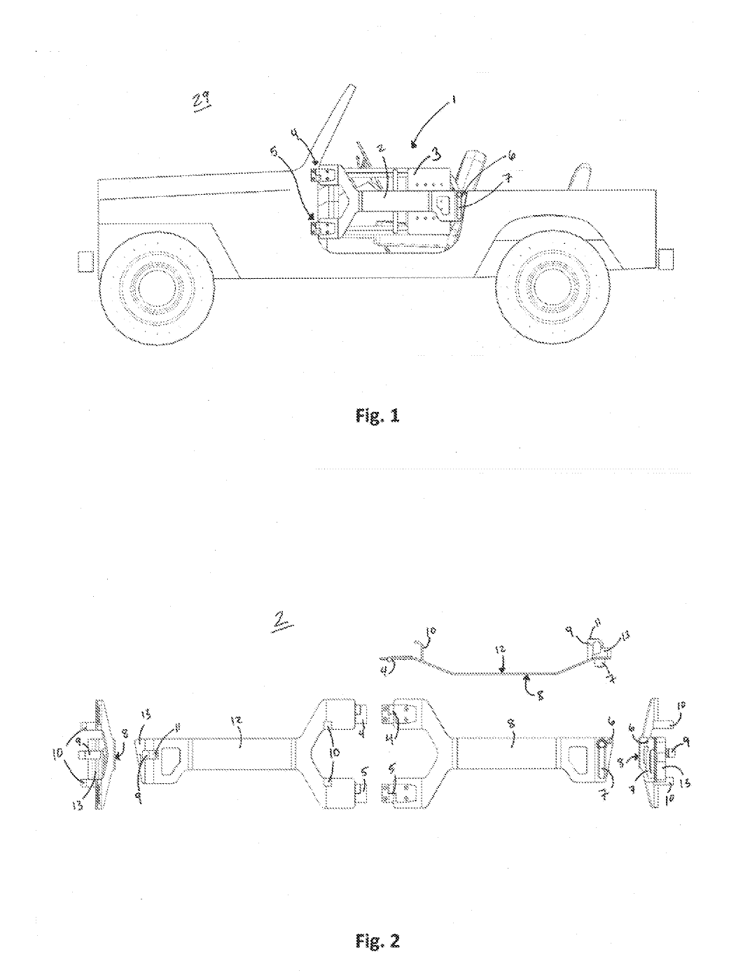

FIG. 2 is a multi-view depiction of a door unit portion of the embodiment depicted in FIG. 1. The image on the far left is of the door unit 2 as seen from the front side. The image second from the left is of door unit 2 as seen from inside the vehicle. The next image to the right is of door unit 2 as seen from outside the vehicle. The image above that one is a top-down view of door unit 2. And the image on the far right is of door unit 2 as seen from the rear side. Door unit 2 features an interior panel 12 and an exterior panel 8. It features an upper hinge 4 and a lower hinge 5 for connecting door unit 2 to a vehicle. At the rear portion of door unit 2 is a door latching mechanism 13, which is compatible with a standard door latch for a vehicle. The door latching mechanism 13 is operated by a door handle 7, which is positioned on the outside portion of door unit 2. Additionally, door latching mechanism 13 preferably may be secured by lock 6, which is also positioned near the rear portion of door unit 2. Preferably, the exterior panel 8 of door unit 2 is relatively convex, and the interior panel 12 is relatively concave, such that door unit 2 has space to integrally affix a specially designed object. Ideally, the exterior panel 8 and interior panel 12 are separated by a space of 2-10 inches to create an interior cavity that is suitable for containing the specially designed object. The object is preferably a chair unit (seen in other figures), which removably attaches to door unit 2 by way of securing hooks 10 near the forward part of door unit 2 and by an interior latching mechanism 9 near the rear part of door unit 2. The securing hooks 10 could be simple hooks, as pictured, or could also be other attachment means such as straps with buckles, buttons, Velcro, magnets, or other securing materials or devices. The interior latching mechanism 9 is ideally a latch with a lock 11, but could also be a latch without a lock or another securing means such as a strap with buckles, buttons, Velcro, magnets, or other securing materials or devices.

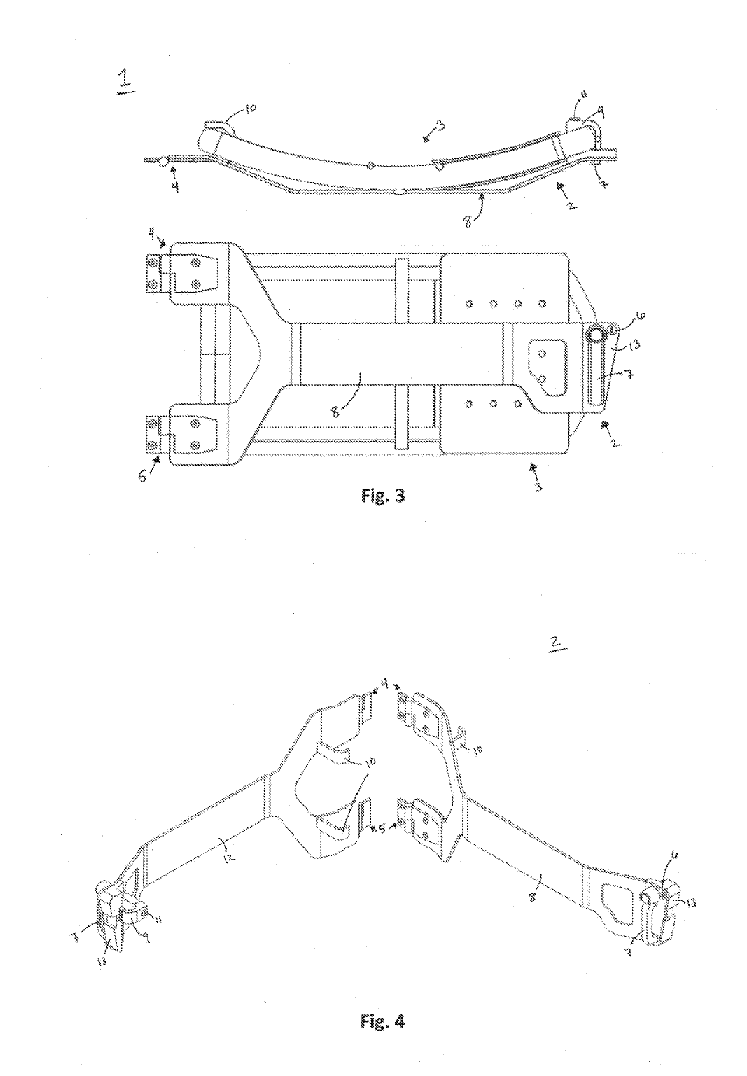

FIG. 3 is a multi-view depiction of the removable integrated door and removable chair system of FIG. 1. Door unit 2 features an upper hinge 4 and a lower hinge 5 for connecting door unit 2 to a vehicle. At the rear portion of door unit 2 is a door latching mechanism 13, which is compatible with a standard door latch for a vehicle. The door latching mechanism 13 is operated by a door handle 7, which is positioned on the outside portion of door unit 2. Additionally, door latching mechanism 13 preferably may be secured by lock 6, which is also positioned near the rear portion of door unit 2. Preferably, the exterior panel 8 of door unit 2 is relatively convex, such that door unit 2 has space to integrally affix a specially designed object, such as removable chair unit 3, as shown. Preferably, removable chair unit 3 attaches to door unit 2 by way of securing hooks 10 near the forward part of door unit 2 and by an interior latching mechanism 9 near the rear part of door unit 2. The securing hooks 10 could be simple hooks, as pictured, or could also be other attachment means such as straps with buckles, buttons, Velcro, magnets, or other securing materials or devices. The interior latching mechanism 9 is ideally a latch with a lock 11, but could also be a latch without a lock or another securing means such as a strap with buckles, buttons, Velcro, magnets, or other securing materials or devices. The chair unit 3 is preferably made of steel but could also be made from other materials, including but not limited to aluminum, titanium, carbon-fiber, molded plastic, wood, or a combination of materials.

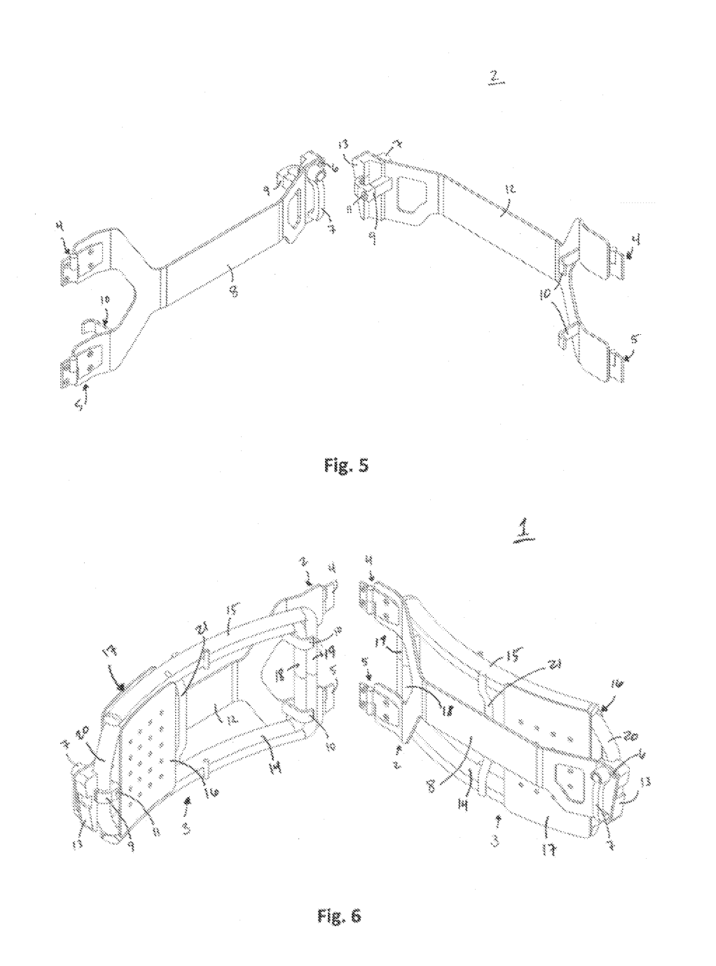

FIGS. 4 and 5 feature isometric views of four sides of a driver's side door unit without removable chair system in accordance with one embodiment of the present invention. Door unit 2 features an interior panel 12 and an exterior panel 8. It features an upper hinge 4 and a lower hinge 5 for connecting door unit 2 to a vehicle. At the rear portion of door unit 2 is a door latching mechanism 13, which is compatible with a standard door latch for a vehicle. The door latching mechanism 13 is operated by a door handle 7, which is positioned on the outside portion of door unit 2. Additionally, door latching mechanism 13 preferably may be secured by lock 6, which is also positioned near the rear portion of door unit 2. Preferably, the exterior panel 8 of door unit 2 is relatively convex, and the interior panel 12 is relatively concave, such that door unit 2 has space to integrally affix a specially designed object. The object is preferably a chair unit (seen in other figures), which removably attaches to door unit 2 by way of securing hooks 10 near the forward part of door unit 2 and by an interior latching mechanism 9 near the rear part of door unit 2. The securing hooks 10 could be simple hooks, as pictured, or could also be other attachment means such as straps with buckles, buttons, Velcro, magnets, or other securing materials or devices. The interior latching mechanism 9 is ideally a latch with a lock 11, but could also be a latch without a lock or another securing means such as a strap with buckles, buttons, Velcro, magnets, or other securing materials or devices.

FIG. 6 features isometric views of two sides of a driver's side integrated door and removable chair system in accordance with one embodiment of the present invention. Door unit 2 features an upper hinge 4 and a lower hinge 5 for connecting door unit 2 to a vehicle. At the rear portion of door unit 2 is a door latching mechanism 13, which is compatible with a standard door latch for a vehicle. The door latching mechanism 13 is operated by a door handle 7, which is positioned on the outside portion of door unit 2. Additionally, door latching mechanism 13 preferably may be secured by lock 6, which is also positioned near the rear portion of door unit 2. Preferably, the exterior panel 8 of door unit 2 is relatively convex, such that door unit 2 has space to integrally affix a specially designed object, such as removable chair unit 3, as shown. Preferably, removable chair unit 3 attaches to door unit 2 by way of securing hooks 10 near the forward part of door unit 2 and by an interior latching mechanism 9 near the rear part of door unit 2. The securing hooks 10 could be simple hooks, as pictured, or could also be other attachment means such as straps with buckles, buttons, Velcro, magnets, or other securing materials or devices. The interior latching mechanism 9 is ideally a latch with a lock 11, but could also be a latch without a lock or another securing means such as a strap with buckles, buttons, Velcro, magnets, or other securing materials or devices.

The chair unit 3 is preferably made of steel but could also be made from other materials, including but not limited to aluminum, titanium, carbon-fiber, molded plastic, wood, or a combination of materials. It preferably comprises two curved panels, each consisting of curved bars with panels. For example, in the featured embodiment, chair unit 3 comprises curved chair back support bars 14 and curved chair seat support bars 15. Curved chair back support bars 14 are attached to chair back 16, which may be made of steel, aluminum, titanium, carbon-fiber, fabric, rubber, molded plastic, wood, or a combination of materials. Curved chair seat bars 15 are attached to chair seat 17, which is preferably made from the same material as chair back 16. Chair back support bars 14 are preferably connected at the top end by a chair top rail 20, and at the bottom end by front chair foot unit 18. Chair seat support bars 15 are preferably connected at the rear (i.e., on the portion that rests on the ground) by rear chair foot unit 19. Additionally, chair seat support bars 15 preferably feature chair cross support 21 to add stability to chair unit 3. When chair unit 3 is in a folded position, chair top rail 20 secures chair unit 3 to door unit 2 by securely attaching to interior latching mechanism 9. Also when chair unit 3 is in a folded position, one or more of front chair foot unit 18 and rear chair foot unit 19 secures chair unit 3 to door unit 2 by attaching to securing hooks 10. Accordingly, while one or more of front chair foot unit 18 and rear chair foot unit 19 may comprise individual feet (rather than a cross-support bar type structure), at least one of front chair foot unit 18 and rear chair foot unit 19 preferably comprises a cross bar for purposes of securely engaging with securing hooks 10. Alternately, the present invention also contemplates embodiments including a single securing hook 10 or other structures for attaching individual feet rather than cross-support bar foot units.

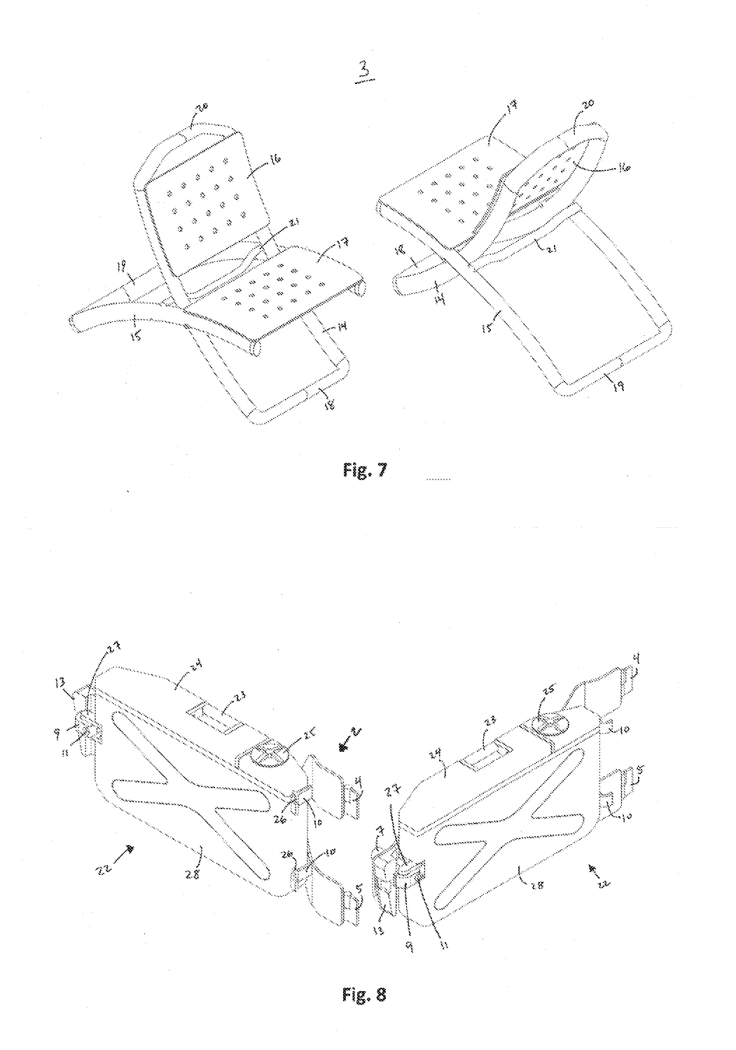

FIG. 7 features isometric views of two sides of a removable chair unit portion of one embodiment of the present invention. The chair unit 3 is preferably made of steel but could also be made from other materials, including but not limited to aluminum, titanium, carbon-fiber, molded plastic, wood, or a combination of materials. It preferably comprises two curved panels, each consisting of curved bars with panels. For example, in the featured embodiment, chair unit 3 comprises curved chair back support bars 14 and curved chair seat support bars 15. Curved chair back support bars 14 are attached to chair back 16, which may be made of steel, aluminum, titanium, carbon-fiber, fabric, rubber, molded plastic, wood, or a combination of materials. Curved chair seat bars 15 are attached to chair seat 17, which is preferably made from the same material as chair back 16. Chair back support bars 14 are preferably connected at the top end by a chair top rail 20, and at the bottom end by front chair foot unit 18. Chair seat support bars 15 are preferably connected at the rear (i.e., on the portion that rests on the ground) by rear chair foot unit 19. Additionally, chair seat support bars 15 preferably feature chair cross support 21 to add stability to chair unit 3. While one or more of front chair foot unit 18 and rear chair foot unit 19 may comprise individual feet (rather than a cross-support bar type structure), at least one of front chair foot unit 18 and rear chair foot unit 19 preferably comprises a cross bar for purposes of securely engaging with the securing hooks of the door unit (not shown in this figure).

While the removable chair unit 3 is ideally integrated into door unit 2, the present invention contemplates a number of other products that could be designed for integration with door unit 2, including a storage bin to hold dry goods or water or an ice chest, survival kit, emergency equipment, or other specially designed equipment. Additionally, in one alternate embodiment, a special pump could be inserted into a sealed container that could then be used as a shower or for other situations, such as an emergency situation.

FIG. 8 features isometric views of two sides of a driver's side integrated door and removable storage bin in accordance with one aspect of the present invention. Door unit 2 features an upper hinge 4 and a lower hinge 5 for connecting door unit 2 to a vehicle. At the rear portion of door unit 2 is a door latching mechanism 13, which is compatible with a standard door latch for a vehicle. The door latching mechanism 13 is operated by a door handle 7, which is positioned on the outside portion of door unit 2. Additionally, door latching mechanism 13 preferably may be secured by lock 6, which is also positioned near the rear portion of door unit 2. Storage bin 22 preferably comprises a sealed compartment 28, a hinged top 24, and a handle 23, as shown. Additionally, storage bin 22 may include a removable cap 25, which is preferably inserted and removed from storage bin 22 by a threaded connection. In an exemplary embodiment, removable cap 25 is used to access one sealed portion of sealed compartment 28 while the hinged top 24 is used to access a separate sealed portion of sealed compartment 28. Thus, in an exemplary embodiment, storage bin 22 contains two or more separate sealed compartments that may act as separate wet and dry compartments, hot and cold compartments, or may serve other complementary functions.

Preferably, removable storage bin unit 22 attaches to door unit 2 by way of securing hooks 10 near the forward part of door unit 2 and by an interior latching mechanism 9 near the rear part of door unit 2. The securing hooks 10 could be simple hooks, as pictured, or could also be other attachment means such as straps with buckles, buttons, Velcro, magnets, or other securing materials or devices. Securing hooks 10 are preferably used to attach storage bin 22 at rear mounting hooks 26. The interior latching mechanism 9 is ideally a latch with a lock 11, but could also be a latch without a lock or another securing means such as a strap with buckles, buttons, Velcro, magnets, or other securing materials or devices. The interior latching mechanism 9 preferably attaches to storage bin 22 by securing front mounting hook 27, which is preferably hinged such that it may be folded away when storage bin 22 is detached from door unit 2.

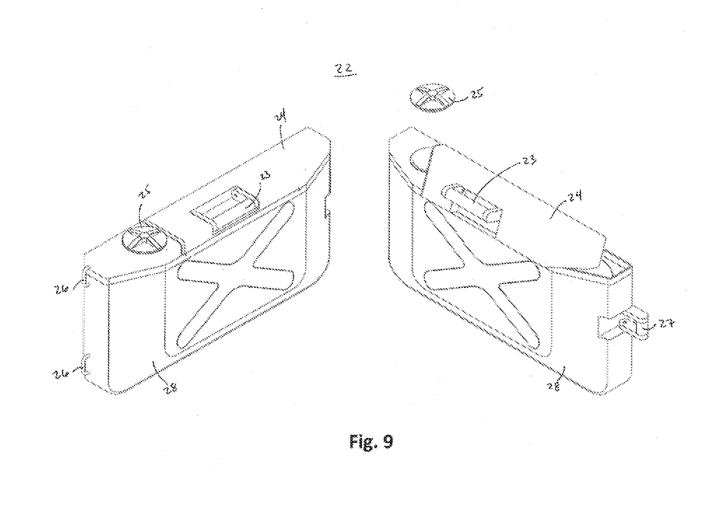

FIG. 9 features isometric views of two sides of a removable storage bin portion of the embodiment depicted in FIG. 8. Storage bin 22 preferably comprises a sealed compartment 28, a hinged top 24, and a handle 23, as shown. Additionally, storage bin 22 may include a removable cap 25, which is preferably inserted and removed from storage bin 22 by a threaded connection. In an exemplary embodiment, removable cap 25 is used to access one sealed portion of sealed compartment 28 while the hinged top 24 is used to access a separate sealed portion of sealed compartment 28. Thus, in an exemplary embodiment, storage bin 22 contains two or more separate sealed compartments that may act as separate wet and dry compartments, hot and cold compartments, or may serve other complementary functions. Storage bin 22 also preferably comprises rear mounting hooks 26 and front mounting hook 27 for attaching to the door unit. Additionally, front mounting hook 27 is preferably hinged, such that it may be folded away when storage bin 22 is detached from the door unit.

Although the invention has been described with reference to one or more particular embodiments, this description is not meant to be construed in a limiting sense. Various modifications of the disclosed embodiments as well as alternative embodiments of the invention will become apparent to persons skilled in the art upon reference to the description of the invention. For example and without limitation, the removable door of the present invention may be formed to integrate with a number of components, including but not limited to a chair (as discussed herein), a jerry can, a storage bin, a cooler, medical kit, search-and-rescue kit, luggage, camping equipment, backpack, weatherproof shell, military gear, or anything else that is suitable for folding and/or fitting within the shape and parameters of the door system. It is therefore contemplated that the appended claims will cover any such modifications or embodiments that fall within the scope of the invention.

1. A removable integrated door system for a vehicle comprising:
a vehicle door having a forward portion and a rear portion, wherein the forward portion is configured to interface with a door hinge of a vehicle and the rear portion is configured to interface with a door latch of said vehicle;
wherein said vehicle door has an interior panel and an exterior panel, said interior panel facing an interior portion of said vehicle when said door is installed and said exterior panel facing external to said vehicle when said door is installed;
wherein said interior panel and said exterior panel are separated by a space, creating an interior cavity of said vehicle door;
an interior latching mechanism located within said interior cavity adapted to secure an object within said cavity.

2. The removable integrated door system of claim 1, further comprising a handle integrated within said vehicle door for opening and closing said door.

3. The removable integrated door system of claim 2, further comprising a lock integrated into said handle.

4. The removable integrated door system of claim 1, wherein said exterior panel of said vehicle door is convex.

5. The removable integrated door system of claim 1, wherein said interior panel and said exterior panel are separated by a distance of between 2 and 10 inches.

6. The removable integrated door system of claim 1, further comprising a foldable chair that is adapted to fit within said interior cavity.

7. The removable integrated door system of claim 6, wherein said foldable chair is adapted to connect to said interior latching mechanism within said interior cavity.

8. The removable integrated door system of claim 1, wherein said vehicle door is a driver's side vehicle door.

9. The removable integrated door system of claim 1, wherein said vehicle door is a passenger's side vehicle door.
